(19) United States
(12) Patent Application Publication
(10) Pub. No.: US 2002/0011296 A1
(43) Pub. Date: Jan. 31, 2002

(54) Pneumatic tire

(76) Inventors: Shinichi Miyazaki, Kobe-shi (JP); Kazumi Yamazaki, Kobe-shi (JP); Osamu Toda, Kobe-shi (JP)

Correspondence Address: BIRCH STEWART KOLASCH & BIRCH, PO BOX 747, FALLS CHURCH, VA, 22040-0747, US

(21) Appl. No.: 09/876,063

(22) Filed: Jun. 8, 2001

(30) Foreign Application Priority Data
Jun. 9, 2000 (JP) 2000-174083

(51) Int. Cl. B60C 9/00

(52) U.S. Cl. 152/529

(57) ABSTRACT

A pneumatic tire comprises a carcass extending between bead portions through a tread portion and sidewall portions, and a belt disposed radially outside of the carcass in the tread portion, wherein the belt comprises at least one monofilament cord ply made of parallel monofilament cords, each monofilament cord is a single metallic filament having a circular cross sectional shape, a diameter of from 0.35 to 0.70 mm, a tensile strength of from 2800 to 3700 Newton/sq.mm, and a bending rigidity of from 35 to 260 gf cm, and the cord count of the monofilament cords in the monofilament cord ply is in a range of from 30 to 50 /5 cm.

The present invention relates to a pneumatic tire with an improved belt being capable of decreasing the tire weight and rolling resistance.

In recent years, it is strongly required to decrease fuel consumption of automobiles from environmental aspects. Accordingly, the tires are also strongly required to decrease the tire weight and rolling resistance.

On the other hand, pneumatic tires provided with a tread reinforcing belt made of steel cords of twisted steel filaments are widely used in various automobiles, e.g. passenger cars, light-trucks, trucks/buses, etc.

In such pneumatic tires, therefore, an attempt to decrease the weight of the steel cord belt by minimizing the diameter of the steel cords was made. But, such multifilament steel cords greatly decrease in the bending rigidity when the cord diameter is decreased, and as a result, the cornering power is decreased to deteriorate the steering stability.

It is therefore, an object of the present invention to provide a pneumatic tire, in which the weight and rolling resistance of the tire is decreased without sacrificing the steering stability and the like.

According to the present invention, a pneumatic tire comprises a carcass extending between bead portions through a tread portion and sidewall portions, and a belt disposed radially outside of the carcass in the tread portion, wherein

the belt comprises at least one monofilament cord ply made of parallel monofilament cords, each monofilament cord is a single metallic filament having a circular cross sectional shape, a diameter of from 0.35 to 0.70 mm, a tensile strength of from 2800 to 3700 Newton/sq.mm, and a bending rigidity of from 35 to 260 gf cm, and

the cord count of the monofilament cords in the monofilament cord ply is in a range of from 30 to 50 /5 cm.

Embodiments of the present invention will now be described in detail in conjunction with the accompanying drawings.

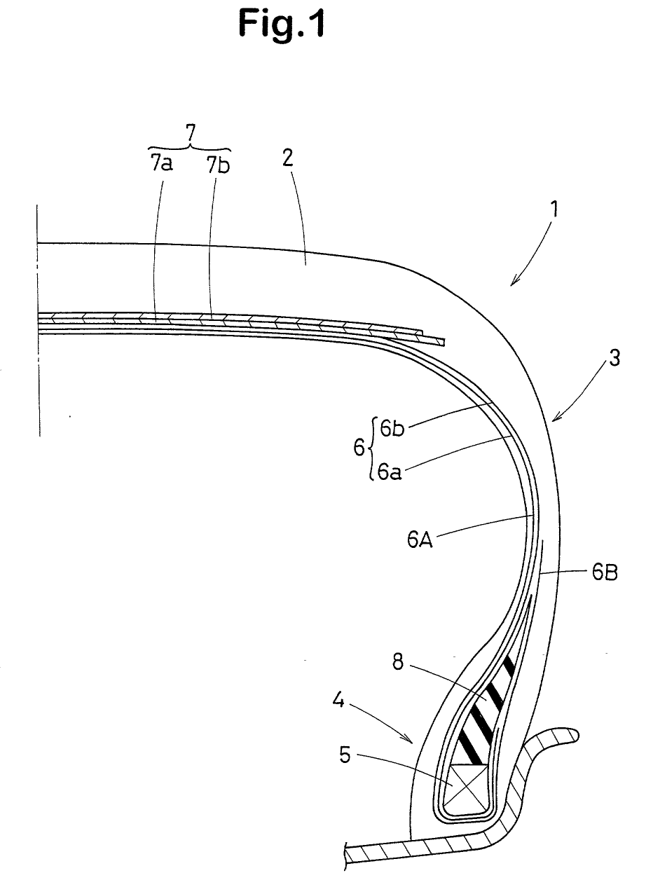

FIG. 1 is a cross sectional view of a radial tire for passenger cars according to the present invention.

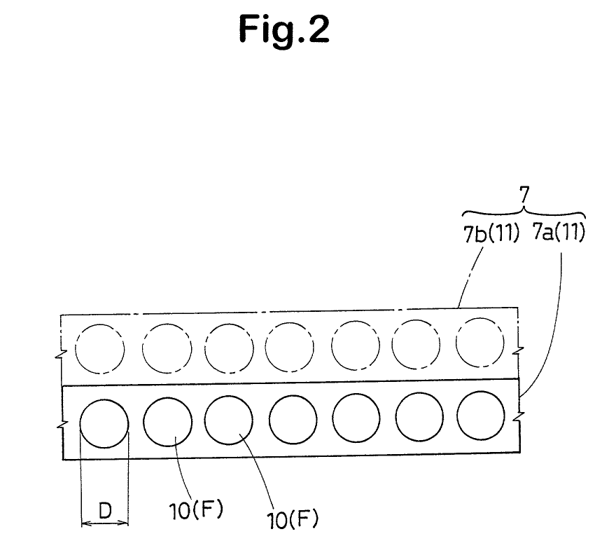

FIG. 2 is an enlarged schematic cross sectional view of the breaker thereof.

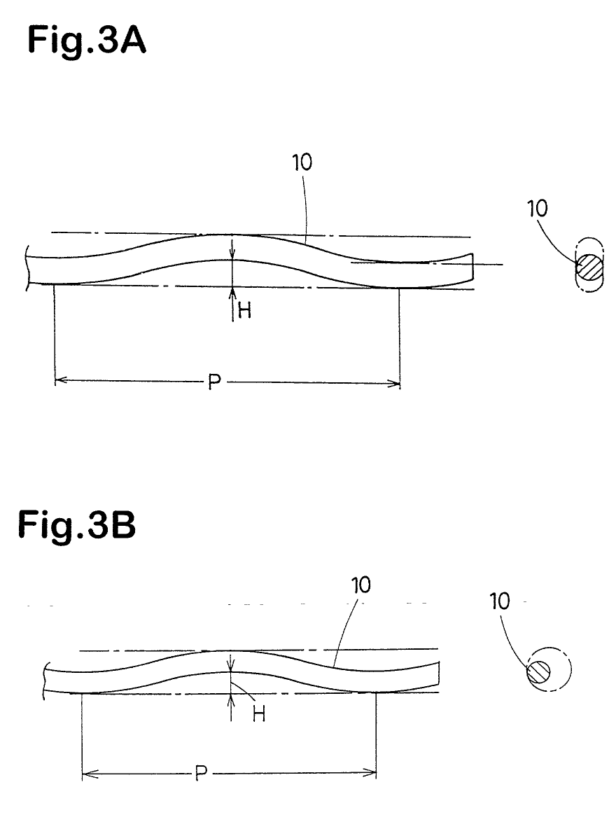

FIG. 3A and FIG. 3B each show an example of the waved monofilament cord.

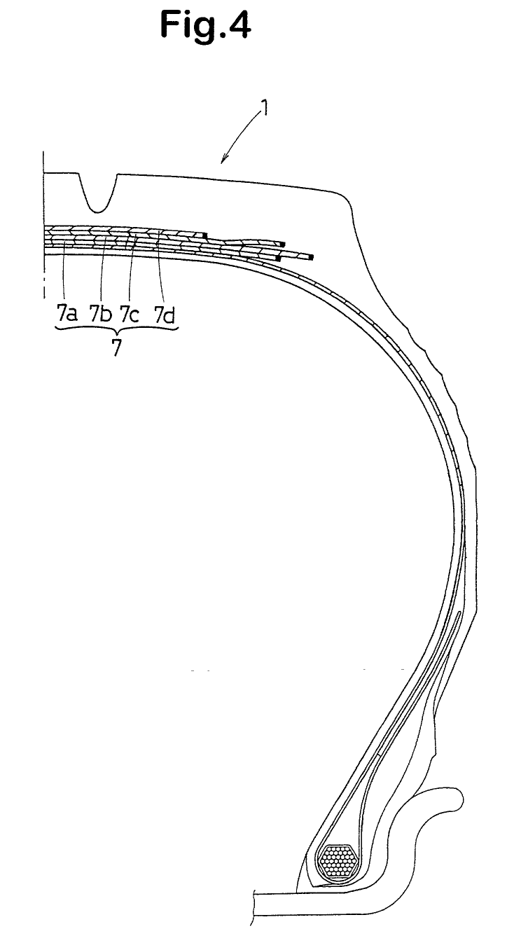

FIG. 4 is a cross sectional view of a heavy duty radial tire for trucks and buses according to the present invention.

In the drawings, pneumatic tire 1 according to the present invention comprises a tread portion 2, a pair of sidewall portions 3, a pair of axially spaced bead portions 4 with a bead core 5 therein, a carcass 6 extending between the bead portions 4, and a belt disposed radially outside the carcass 6 in the tread portion 2.

The carcass 6 comprises at least one ply of cords arranged radially at an angle of from 75 to 90 degrees with respect to the tire equator and extending between the bead portions 4 through the tread portion 2 and sidewall portions 3 and turned up around the bead core 5 in each of the bead portions 4 from the inside to the outside of the tire to form a pair of turned up portions 6B and a main portion 6A therebetween.

For the carcass cords, an organic fiber cord, e.g. nylon, rayon, polyester, aromatic polyamide and the like, made of a number of organic filaments or fibers twisted together can be used. Also, steel cords made of a plurality of steel filaments twisted together can be used.

Each of the bead portions 4 is provided with a bead apex 8 made of a hard rubber compound extending radially outwardly while tapering towards its radially outer end from its radially inner end adjoining the bead core 5. In case that the carcass is provided with the turned up portions 6B, the bead apex 8 is usually disposed between the carcass ply turned up portion 6B and main portion 6A.

The belt comprises a breaker 7 and optionally a band.

The breaker 7 comprises two cross plies of parallel cords laid at an angle of from 15 to 30 degrees with respect to the tire equator. Here, the term “cross plies” means that the cords of one ply are inclined reversely to the cords of the other ply with respect to the tire equator.

The band (not shown) is disposed radially outside the breaker 7 to tighten the tread portion. The band can be formed by spirally windings at least one cord or winding a strip of parallel cords. In any case, the cord angle is not more than 5 degrees with respect to the tire equator.

As to the above-mentioned two cross plies of the breaker 7, at least one of, preferably each of them is a monofilament cord ply 11 made of monofilament cords 10 laid parallel with each other. In the monofilament cord ply 11, the cord count of the monofilament cords 10 is in a range of from 30 to 50 (/5 cm width).

The monofilament cord 10 is a single metallic filament F having a substantially circular cross sectional shape. The diameter D thereof is set in a range of from 0.35 to 0.70 mm. The monofilament cord 10 has a tensile strength of from 2800 to 3700 Newton/sq.mm, preferably 3000 to 3600 Newton/sq.mm, and a bending rigidity of from 35 to 260 gf cm, preferably 60 to 240 gf cm. Thus, the monofilament cord 10 is greatly increased in the tensile strength and bending rigidity. By using such monofilament cord 10, a sufficient cornering power can be obtained, while maintaining a necessary cord durability, and a weight reduction can be achieved without sacrificing the ride comfort, while maintaining a good steering stability.

If the tensile strength is less than 2800 Newton/sq.mm, the cord rupture strength becomes insufficient when the rigidity of the cord is properly adjusted. If the tensile strength is more than 3700 Newton/sq.mm, the toughness and fatigue resistance of the cord are greatly decreased. In any case, the cord durability and the belt durability decreases.

If the bending rigidity is less than 35 gf cm (0.343 Newton cm), the cornering power becomes insufficient for improving the steering stability. If the bending rigidity is more than 260 gf cm (2.548 Newton cm), ride comfort deteriorates.

The bending rigidity of the cord was measured with a V-5 stiffness tester model 150-D of Taber Industries, U.S.A. as a force in gram centimeter required to bend the cord 15 degrees.

If the diameter D is less than 0.35 mm, the cord rupture strength and rigidity are insufficient. If the diameter D is more than 0.70 mm, the rigidity becomes too high and the ride comfort deteriorates.

If the cord count is less than 30 (/5 cm), the belt rigidity becomes insufficient, and share strain between the plies increases, and the tendency toward cord rupture and belt edge separation increases. If the cord count is more than 50 (/5 cm), the weight and cost increase and the belt becomes inferior in the working property.

In order to increase the tensile strength and bending rigidity up to the above-mentioned ranges, a high-carbon steel whose carbon content is in a range of from 0.80 to 0.98 weight %, preferably 0.92 to 0.98 weight % is preferably used as the material of the monofilament cord. In case of need, chromium can be further added in order to control the pro-eutectoid cementite thereof.

The above-mentioned monofilament cord 10 is a non-waved cord, namely, the cord is substantially straight when free of load. But, it is also possible to use a waved cord as shown in FIGS. 3A and 3B. FIG. 3A shows an example which is two-dimensionally waved. FIG. 3B shows an example which is three-dimensionally waved (spirally waved). From a point of view of steering stability, it is preferable that the wave pitch P is increased to more than 14.0 mm, and the wave height H is decreased into a range of from 0.002 to 0.02 times the wave pitch P.

Passenger car radial tire

FIG. 1 shows an embodiment of the present invention which is a radial tire for passenger cars.

In this embodiment, the carcass 6 is composed of two plies 6a and 6b of organic fiber cords (polyester fiber cords) arranged at almost 90 degrees with respect to the tire equator.

The belt includes a breaker 7 and a band (not shown).

The band is disposed radially outside the breaker 7 to prevent the breaker from being lifted during high speed running. The band is formed by spirally winding organic fiber cords (in this example nylon cords) at an angle of not more than 5 degrees with respect to the tire equator. The band extends over at least breaker edge portions to restrict their motion. It is of course possible to form the band to extend all over the breaker width.

The breaker 7 is composed of two cross plies 7a and 7b of parallel cords laid at an angle of from 15 to 30 degrees with respect to the tire equator.

In this example, all of the breaker plies 7a and 7b are a monofilament cord ply 11 made of monofilament cords 10 laid parallel with each other.

In case of passenger car tire, the rupture strength of the monofilament cord is preferably set in a range of from 500 to 700 Newton, and the diameter D is preferably set in a range of from 0.35 to 0.55 mm.

Heavy duty radial tire

FIG. 4 shows another embodiment of the present invention which is a heavy duty radial tire for trucks and buses.

In this embodiment, the carcass 6 is composed of a single ply of multifilament steel cords arranged at 90 degrees with respect to the tire equator.

The belt is composed of a breaker 7 only.

In case of a heavy duty radial tire, the breaker 7 is preferably composed of three plies 7a, 7b and 7c or four plies 7a, 7b, 7c and 7d. The radially innermost first ply 7a is made of parallel cords laid at an angle of from 45 to 70 degrees. The radially outer second, third and fourth plies 7b, 7c and 7d are each made of parallel cords laid at an angle of from 15 to 30 degrees. As to the inclining direction of the cords in each ply with respect to the tire equator, the first and second breaker plies 7a and 7b are the same but reverse to the third and fourth breaker plies 7c and 7d. For example, the first and second breaker plies 7a and 7b have right side upward inclinations, and the third and fourth breaker plies 7c and 7d have left side upward inclinations.

As explained above, at least one, preferably two of the three or four breaker plies are the above-mentioned monofilament cord ply 11.

In case of two monofilament cord plies 11, it is preferable that the first and fourth plies 7a and 7d or the second and third plies 7b and 7c are the monofilament cord ply 11.

Further, in case of a heavy duty radial tire, the rupture strength of the monofilament cord is preferably set in a range of from 700 to 1000 Newton, and the diameter D is preferably set in a range of from 0.45 to 0.70 mm.

Comparison Test

Test tires were made and tested for the steering stability, ride comfort and rolling resistance.

(1) Steering stability test

A test car provided on all the wheels with test tires was run on a dry asphalt road surface of a tire test course, and the test driver evaluated the steering stability into five ranks from the handle responsiveness, rigidity, road grip and the like. The larger the rank number, the better the steering stability.

(2) Ride comfort test

The test car was run on dry rough roads (including asphalt road, stone-paved road and graveled road) and the test driver evaluated the ride comfort into five ranks, based on harshness, damping, thrust-up, etc. The larger the rank number, the better the ride comfort.

(3) Rolling resistance test

The rolling resistance was measured according to SAE J-1269. The results are indicated by an index based on Conventional tire being 100. The larger the index number, the smaller the rolling resistance.

(4) Tire weight

The difference from Conventional tire is shown.

As described above, in the pneumatic tires according to the present invention, the tire weight and rolling resistance can be reduced to improve the fuel consumption, without deteriorating the ride comfort and the steering stability.

TABLE 1
(Tire size: 165/70R13 for passenger cars)

| Tire | Conventional | Ref. 1 | Ex. 1 | Ex. 2 |
|---|---|---|---|---|
| Structure | | | | |
| Carcass | *1 | *1 | *1 | *1 |
| Breaker | | | | |
| Number of ply | 2 | 2 | 2 | 2 |
| Cord angle (deg.) | +20/−20 | +20/−20 | +20/−20 | +20/−20 |
| Cord count (/5 cm) | 40 | 40 | 40 | 35 |
| Number of monofilament cord ply | 0 | 0 | 2 | 2 |
| Weight of ply (g/sq.m) | 1150 | 1150 | 1000 | 1240 |
| Breaker cord | | | | |
| Structure | 1 × 5 × 0.25 | 1 × 5 × 0.25 | monofilamnent | monofilamnent |
| Code diameter (mm) | 0.67 | 0.67 | 0.45 | 0.5 |
| Carbon content (wt %) | 0.82 | 0.92 | 0.92 | 0.92 |
| Tensile strength (Newton/sq. mm) | 2600 | 3450 | 3400 | 3350 |
| Bending rigidity (gf cm) | 28 | 33 | 56 | 84 |
| Weight (g/m) | 1.92 | 1.92 | 1.25 | 1.55 |
| Rapture strength (Newton) | 638 | 846 | 541 | 658 |
| Band | *2 | *2 | *2 | *2 |
| Test Results | | | | |
| Tire weight difference (g) | 0 | 0 | −121 | −115 |
| Steering stability | 2.9 | 2.9 | 3 | 3 |
| Ride comfort | 3 | 3.1 | 3 | 3 |
| Rolling resistance | 100 | 100 | 103 | 104 |

*1: Two plies of 1670 dtex/2 polyester cords arranged at 90 degrees
*2: One ply of spirally wound nylon-66 cords

TABLE 2
(Tire size: 11R22.5 for trucks/buses)

| Tire | Conventional | Ex. |
|---|---|---|
| Structure | | |
| Carcass | | |
| Number of ply | 1 | 1 |
| Cord | steel (3 + 6 × 0.23) | steel (3 + 6 × 0.23) |
| Cord angle (deg.) | 90 | 90 |
| Breaker | | |
| Number of ply | 4 | 4 |
| Cord angles (deg.) *1 | +65/+20/−20/−20 | +65/+20/−20/−20 |
| Cord count (/5 cm) | 26 | 37 |
| Cord structure *2 | | |
| First ply | multifilament | multifilament |
| Second ply | multifilament | monofilament |
| Third ply | multifilament | monofilament |
| Fourth ply | multifilament | multifilament |
| Weight of ply (g/sq. m) | 2260 | 1650 |
| Band | none | nine |
| Test Results | | |
| Tire weight | 0 | −105 |
| Steering stability | 2.9 | 3.1 |
| Ride comfort | 3 | 3 |
| Rolling resistance | 100 | 103 |
| Cord | multifilament | monofilament |
| Structure | 3 × 0.20 + 6 × 0.35 | — |
| Cord diameter D (mm) | 0.67 | 0.6 |
| Carbon content (wt %) | 0.82 | 0.9 |
| Tensile strength | 2600 | 3300 |
| (Newton/sq. mm) | | |
| Weight (g/m) | 4.4 | 2.22 |
| Rapture strength (Newton) | 1410 | 933 |

*1: first/second/third/fourth
*2: see the following table

1. A pneumatic tire comprising
a carcass extending between bead portions through a tread portion and sidewall portions, and
a belt disposed radially outside the carcass in the tread portion and comprising at least one monofilament cord ply,
the monofilament cord ply made of parallel monofilament cords,
each monofilament cord being a single metallic filament having a circular cross sectional shape, a diameter of from 0.35 to 0.70 mm, a tensile strength of from 2800 to 3700 Newton/sq.mm, and a bending rigidity of from 35 to 260 gf cm, and
the cord count of the monofilament cords in said monofilament cord ply being in a range of from 30 to 50 /5 cm.

2. The pneumatic tire according to claim 1, wherein
said at least one monofilament cord ply is two monofilament cord plies, and
the monofilament cords in one of the two monofilament cord plies are inclined reversely to the monofilament cords in the other with respect to the tire equator.

3. The pneumatic tire according to claim 1, wherein
said belt include a band disposed radially outside said at least one monofilament cord ply,
said band is made of organic fiber cords wound at an angle of not more than 5 degrees with respect to the tire equator.

4. The pneumatic tire according to claim 1, wherein
the rupture strength of the monofilament cord is in a range of from 500 to 700 Newton, and
said diameter is in a range of from 0.35 to 0.55 mm.

5. The pneumatic tire according to claim 1, wherein
the rupture strength of the monofilament cord is in a range of from 700 to 1000 Newton, and
said diameter is in a range of from 0.45 to 0.70 mm.

6. The pneumatic tire according to claim 1, wherein
the monofilament cord is not waved.

7. The pneumatic tire according to claim 1, wherein
the monofilament cord is waved, and the wave pitch is more than 14.0 mm, and the wave height is a range of from 0.002 to 0.02 times the wave pitch.
